(19) United States
(12) Patent Application Publication
(10) Pub. No.: US 2021/0021149 A1
(43) Pub. Date: Jan. 21, 2021

(54) HIGH BAY BATTERY BACKUP

(71) Applicant: Aleo Lighting, Inc., Cerritos, CA (US)

(72) Inventor: Brandon Yuan, Long Beach, CA (US)

(21) Appl. No.: 16/517,018

(22) Filed: Jul. 19, 2019

(51) Int. Cl. H02J 9/06; H05B 33/08; H02J 7/00; F21S 9/02

(52) U.S. Cl. CPC H02J 9/061; H05B 33/0845; F21Y 2115/10; F21S 9/02; H02J 7/0068

(57) ABSTRACT

A battery backup module has a housing including a heatsink having vertically oriented heat dissipation fins extending horizontally from the heatsink. The heatsink includes vertically oriented heat dissipation grooves. A battery is housed within the housing and thermally connected to the heatsink. A circuit includes a processor and the circuit is configured to govern battery charging, and battery usage. The processor is configured to handle dimming control. The circuit includes a battery charging circuit, a power supply circuit and a dimming circuit. A module power line in is connected to the circuit, supplying electricity to the circuit. A module power line out configured to connect to a lamp power line of a lamp.

### FIELD OF THE INVENTION

The present invention is in the field of a high bay battery backup.

### DISCUSSION OF RELATED ART

For example, in the U.S. Pat. No. 9,560,703 Dimming Control For Emergency Lighting Systems by inventor John J. Trainor, published Jan. 31, 2017 the abstract discloses, “An emergency lighting module for providing emergency power to a solid state luminaire includes a microcontroller, and a detector coupled to the microcontroller and configured to detect a status signal indicative of a status of an AC line voltage, the emergency lighting module is configured to output a dimming control signal to the solid state luminaire in response to a reduction of the AC line voltage. The microcontroller is further configured to output a select signal to the solid state luminaire to cause the solid state luminaire to dim in accordance with the dimming control signal when the dimming control signal is output.”

For example, in the U.S. Pat. No. 9,699,869 Wireless Lighting And Electrical Device Control System by inventor Anthony Holland, published Jul. 4, 2017 the abstract discloses, “The invention provides a plurality of individually addressable radio frequency (RF) modules, any of which can be installed with any electrical device such as an ambient condition sensor or an ambient condition modifier. A prime example would be a light fixture, whether with or without a dimmable light source efficient dimming and integrated smart sensor networking related to the lighting system itself or to other systems such as parking monitors, fire alarm monitors or security alarm monitors. Independent control processing in each lighting fixture or electrical device allows a multiplicity of sensors to be locally employed and their data to control local conditions or communicate to adjoining fixtures and electrical devices and thereby control larger portions of the lighting system network or network to several unrelated systems.”

For example, in the U.S. Pat. No. 6,940,230 Dual Reflector Lighting System by inventor Robson L. Splane, Jr., published Aug. 11, 1998 the abstract discloses, “Methods, apparatus, and systems are provided concerning modular lamp controllers. In one embodiment, a modular lamp controller dims a high intensity discharge lamp based upon occupancy. The lamp has a port within its fixture, and the port is coupled to a lamp capacitor. The modular lamp controller includes a housing, a plug, a capacitor, a switch, an occupancy sensor, a switch controller, a power supply, an interchangeable lens assembly, and a mounting adapter assembly. The plug is adapted to connect to the port. The capacitor couples in series with the lamp capacitor when the plug is attached to the port. The switch defines a full and reduced power state of the lamp. The occupancy sensor generates a signal indicating the presence of an occupant within a monitored space. The switch controller operates the switch to activate the full or reduced power state of the lamp based upon the occupancy signal. The power supply operates using current from the lamp when the plug is attached to the port. The interchangeable lens assembly acts as optics for the occupancy sensor, and the mounting adapter assembly mounts and locks the modular lamp controller into position.”

For example, in the U.S. Pat. No. 579,176 Modular Lamp Controller by inventor Douglas D. Myron, published Sep. 6, 2005 the abstract discloses, “A dual reflector lighting system having an adjusting assembly for independently adjusting an inner reflector and an outer reflector relative to a gaseous discharge lamp. The lighting system includes a housing having a ballast assembly mounted therein. An elongated tubular adjusting member has one end thereof connected to the bottom of the housing. A lamp socket for receiving a gaseous discharge lamp is mounted to the other end of the adjusting member. The lamp socket is electrically connected to the ballast assembly. The system includes both an outer reflector and an inner reflector mounted coaxially about the gaseous discharge lamp. The outer reflector is mounted to the tubular adjusting member for movement relative thereto to adjust the outer reflector relative to the gaseous discharge lamp. The inner reflector is connected to the adjusting member for adjusting the inner reflector relative to the gaseous discharge lamp. The invention also covers a dual reflector assembly including an outer reflector, an inner reflector and an adjusting assembly which is adapted to be mounted to the housing of a gaseous discharge lamp fixture. The invention also covers a retrofit kit which includes an outer reflector, an inner reflector, a lamp socket and a adjusting assembly for adjusting the inner reflector and outer reflector relative to the lamp of a fixture. The retrofit kit may also include a reduced wattage ballast and a gaseous discharge lamp.”

For example, in the U.S. Pat. No. 5,582,479 Dual Reflector High Bay Lighting System by inventor James E. Thomas, published Dec. 10, 1996 the abstract discloses, “A dual reflector lighting system having a housing, a ballast and a lamp socket connected to receive a gaseous discharge or high intensity discharge (HID) lamp. An outer reflector is mounted to the housing to reflect a portion of light from the lamp. An inner or auxiliary reflector is mounted coaxially with the lamp to reflect a substantial amount of light from the lamp downwardly. The auxiliary reflector is preferably adjustable relative to the lamp. The invention also covers a dual reflector assembly, including an outer reflector and an inner reflector, adjustable relative to each other which is adapted to be mounted to a HID fixture. The invention also covers an auxiliary reflector having a predetermined size and shape adapted to fit within an outer reflector of a HID fixture and preferably includes facilities for adjusting the auxiliary reflector relative to the outer reflector. The invention also covers a retrofit kit which includes a ballast, an auxiliary reflector and facilities for connecting the auxiliary reflector to an existing HID fixture and for adjusting the auxiliary reflector so that a substantial portion of light is concentrated downwardly.”

### SUMMARY OF THE INVENTION

A battery backup module has a housing including a heatsink having vertically oriented heat dissipation fins extending horizontally from the heatsink. The heatsink includes vertically oriented heat dissipation grooves. A battery is housed within the housing and thermally connected to the heatsink. A circuit includes a processor and the circuit is configured to govern battery charging, and battery usage. The processor is configured to handle dimming control. The circuit includes a battery charging circuit, a power supply circuit and a dimming circuit. A module power line in is connected to the circuit, supplying electricity to the circuit. A module power line out configured to connect to a lamp power line of a lamp.

The processor is configured for simultaneously control of battery charging through the battery charging circuit, dimming control through the dimming circuit, and power supply control to the lamp through a power supply circuit. The processor is configured to provide continual power to the lamp while slowly charging the battery during normal operation mode, but when power is interrupted to dim the lamp and change to battery power in an emergency mode. The variable resistor can provide a preset dimming level input to the processor.

### BRIEF DESCRIPTION OF THE DRAWINGS

FIG. 1 is an exploded view of the physical configuration of the present invention.

FIG. 2 is a circuit diagram of a first part of the invention including a high-voltage portion. FIG. 3 is a circuit diagram of the second part of the invention including a processor and low-voltage portion.

The following call out list of elements can be useful guide in referencing the element numbers of the drawings.
17 circuit
18 ring opening
19 heat sink
20 backup module
21 backup module ring connector
22 upper bracket
23 upper bracket channel
24 upper bracket side wall
25 heat sink fins
26 upper bracket top wall
27 module power line in
28 bracket indent
29 connector opening wall
30 connector openings
31 backup module lower ring connector
32 lower bracket sidewall
33 lower bracket channel
34 heat sink grooves
35 heat sink bracket slot
36 lower bracket bottom wall
37 battery
38 module power line out
39 lower bracket
40 lamp
41 lamp power line
42 battery dimmer line
43 lamp dimmer line
44 lamp driver
45 lamp hook
46 hook pin
47 lamp fins
48 lamp lens
49 lamp connection openings
BD01 battery diode
C1 first capacitor
C2 second capacitor
C3 third capacitor
C4 fourth capacitor
C5 fifth capacitor
C6 sixth capacitor
C7 seventh capacitor
C8 eighth capacitor
C9 ninth capacitor
C10 tenth capacitor
C11 eleventh capacitor
C12 twelfth capacitor
C13 thirteenth capacitor
C14 fourteenth capacitor
C15 fifteenth capacitor
C16 sixteenth capacitor
C17 seventeenth capacitor
C18 eighteenth capacitor
C19 nineteenth capacitor
C20 twentieth capacitor
C21 twenty-first capacitor
C22 twenty-second capacitor
C23 twenty-third capacitor
C24 twenty-fourth capacitor
C25 twenty-fifth capacitor
C26 twenty-sixth capacitor
C27 twenty-seventh capacitor
C28 twenty-eighth capacitor
C29 twenty-ninth capacitor
C30 thirtieth capacitor
C31 thirty-first capacitor
C61 sixty-first capacitor
C84 eighty-fourth capacitor
C85 eighty-fifth capacitor
C102 one hundred second capacitor
C103 one hundred third capacitor
CC1 first electrolytic capacitor
CC2 second electrolytic capacitor
CC3 third electrolytic capacitor
CX1 capacitor for transformer
CY1 first ground capacitor
CY2 second ground capacitor
D1 first diode
D2 second diode
D3 third diode
D4 fourth diode
D5 fifth diode
D6 sixth diode
D7 seventh diode
D8 eighth diode
D9 ninth diode
D10 tenth diode
D11 eleventh diode
D12 twelfth diode
D+ positive diode
EARTH earth
FUSE fuse
K10 contact bus
L1 first coil
L3 third coil
P1 first connector
P2 second connector
P3 third connector
P4 fourth connector
P5 fifth connector
P6 sixth connector
P7 seventh connector
P8 eighth connector
P9 ninth connector
P10 tenth connector
P11 eleventh connector
P12 twelfth connector
P13 thirteenth connector
Q1 first transistor
Q2 second transistor
Q3 third transistor
Q4 fourth transistor
Q5 fifth transistor
Q6 sixth transistor
Q7 seventh transistor
Relay2 second relay
R01 first resistor
R02 second resistor
R3 third resistor
R1 first resistor
R4 fourth resistor
R5 fifth resistor
R6 sixth resistor
R7 seventh resistor
R8 eighth resistor
R8A first charging resistor
R8C second charging resistor
R8CC third charging resistor
R9 ninth resistor
R10 tenth resistor
R10A supplemental tenth resistor
R11 eleventh resistor
R12 twelfth resistor
R13 primary thirteenth resistor
R13D secondary thirteenth resistor
R13E tertiary thirteenth resistor
R13H quaternary thirteenth resistor
R14 fourteenth resistor
R15 fifteenth resistor
R16 sixteenth resistor
R17 seventeenth resistor
R18 eighteenth resistor
R19 nineteenth resistor
R20 twentieth resistor
R21 twenty-first resistor
R22 twenty-second resistor
R23 twenty-third resistor
R24 twenty-fourth resistor
R25 twenty-fifth resistor
R26 twenty-sixth resistor
R27 twenty-seventh resistor
R28 twenty-eight resistor
R29 twenty-nine resistor
R30 thirtieth resistor
R31 thirty-first resistor
R32 thirty-second resistor
R33 thirty-third resistor
R34 thirty-fourth resistor
R35 thirty-fifth resistor
R36 thirty-sixth resistor
R37 thirty-seventh resistor
R38 thirty-eighth resistor
R39 thirty-ninth resistor
R40 fortieth resistor
R41 forty-first resistor
R42 forty-second resistor
R43 forty-third resistor
R44 forty-fourth resistor
R45 forty-fifth resistor
R46 forty-sixth resistor
R47 forty-seventh resistor
R48 forty-eighth resistor
R49 forty-ninth resistor
R50 fiftieth resistor
R51 fifty-first resistor
R52 fifty-second resistor
R61 sixty-first resistor
R62 sixty-second resistor
R80 eightieth resistor
R81 eighty-first resistor
R82 eighty-second resistor
R87 eighty-seven resistor
R88 eighty-eight resistor
R89 eighty-ninth resistor
R90 ninetieth resistor
R91 ninety-first resistor
R101 one hundred first resistor
RV1 variable resistor
S1 first switch
T2A first transformer
T2B second transformer
U1 first inseparable assembly
U2A second inseparable assembly
U2B third inseparable assembly
U3 fourth inseparable assembly
U4A fifth inseparable assembly
U4B sixth inseparable assembly
U4C seventh inseparable assembly
U5 eighth inseparable assembly
U6A ninth inseparable assembly
U6B tenth inseparable assembly
U7A eleventh inseparable assembly
U7B twelfth inseparable assembly
U7C thirteenth inseparable assembly
U8 fourteenth inseparable assembly (processor)
U9A fifteenth inseparable assembly
U9B sixteenth inseparable assembly
U9C seventeenth inseparable assembly
Z1 ground diode
Z3 second schottky diode
Z4 first schottky diode
Z5A first amplifier
Z5B second amplifier

### DETAILED DESCRIPTION OF THE PREFERED EMBODIMENT

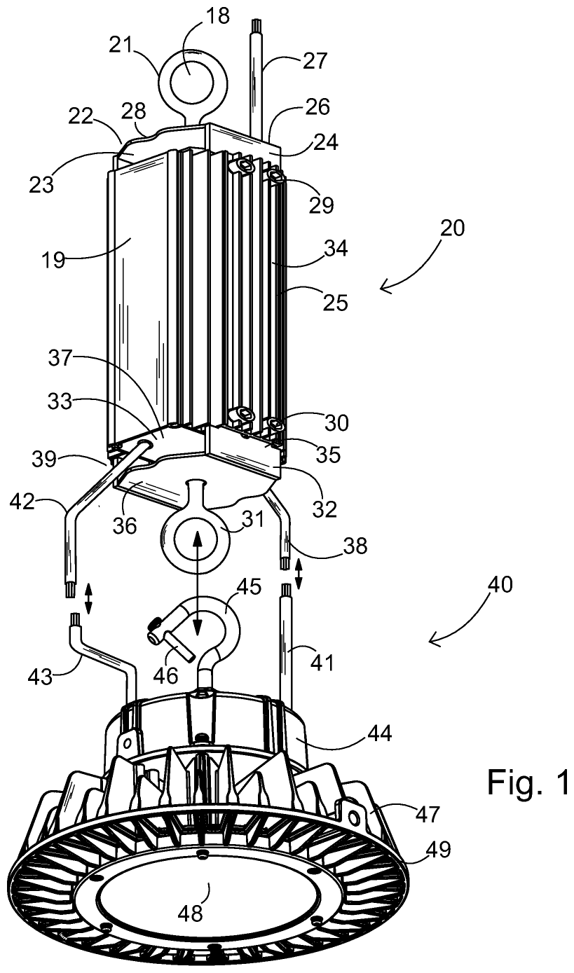

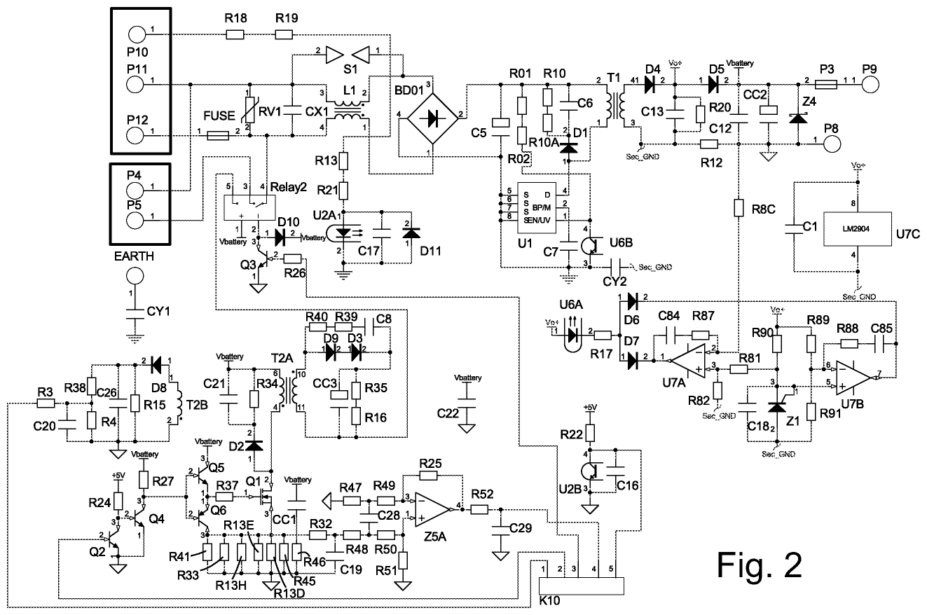

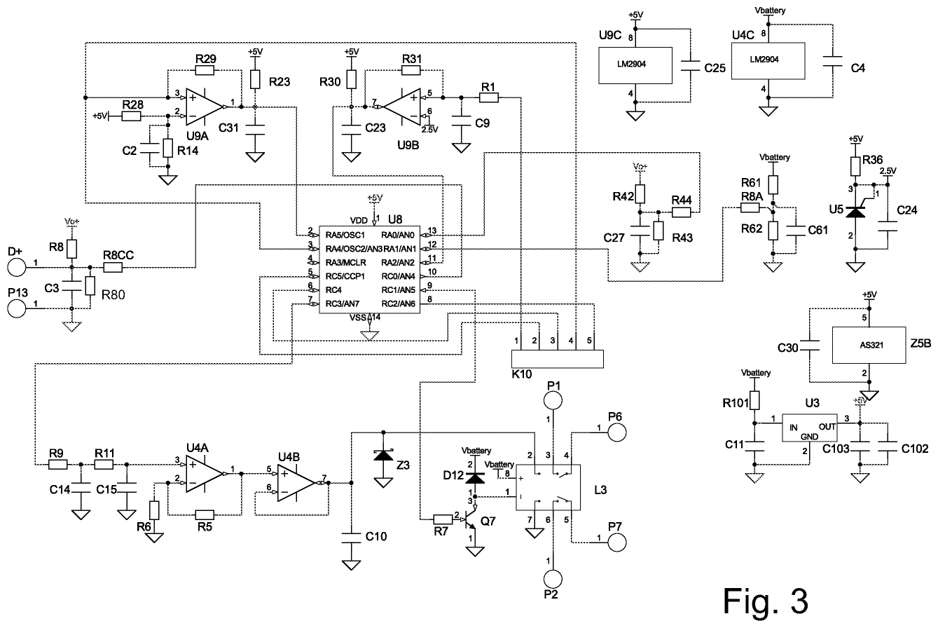

As seen in FIG. 1, a ring opening 18 formed in the backup module ring connector 21 to support the present invention which is a battery backup module 20 for a high bay light such as a high bay LED light. The backup module includes a heat sink 19, which forms a housing for circuitry. The heatsink 19 preferably is formed with heatsink grooves 34. The heatsink 19 holds the circuitry of the battery backup module 20 and absorbs heat from it. The circuitry is shown in FIGS. 2, 3. The upper bracket 22 has an upper bracket channel 23 allowing airflow between the upper bracket 22 and the heatsink 19. The upper bracket 22 has an upper bracket side wall 24 and an upper bracket top wall 26 which has a bracket indent 28. The bracket indent 28 is formed on a left and right side of the upper bracket 22 and may receive the cable of the module power line in 27.

Heat sink fins 25 are vertically oriented and extend horizontally from the heatsink 19. The battery backup module is powered using a module power line in 27. The heatsink 19 can be formed of a thermally conductive material such as aluminum and have connector openings 30. The connector openings 30 can receive screws for access to an interior of the heatsink 19. The connector openings 30 may also have one or more connector opening walls 29.

The backup module lower ring connector 31 receives the lamp hook 45. The backup module lower ring connector 31 is mounted to a lower bracket. The lower bracket 39 has a lower bracket sidewall 32 extending vertically to provide a lower bracket channel 33 so that the lower bracket bottom wall 36 is set apart from the heatsink 19. The lower bracket sidewall 32 may extend into a heatsink bracket slot 35 formed on the heatsink 19. The heat sink bracket slot 35 can be formed between different pieces of the heatsink 19. The heatsink 19 can be made in multiple pieces such as a main housing and a lid for example. The battery 37 is housed within the heatsink. Preferably, the battery is thermally connected to the heatsink for heat dissipation.

From the lower portion of the heatsink 19, a module power line out 38 extends downwardly and connects to the lamp power line 41 of the lamp 40. Similarly, a battery dimmer line 42 extends from the backup module and connects to a lamp dimmer line 43 of the lamp 40. The lamp 40 has a lamp driver 44. The lamp 40 has a hook pin 46 that secures the lamp book 45 to the lamp driver 44. Multiple lamp fins 47 surround the lamp lens 48 and the lamp fins 47 have lamp connection openings 49 that provide natural convection heat transfer.

The battery backup module 20 can be implement with a dimmer control that controls the 0-10V dimmer line of the lamp. This sets the lamp to a lower level according to available battery power. The battery backup module 20 can be preprogrammed to have an emergency level of lighting that is less than 100%. A circuit diagram is provided for implementing the battery backup module 20.

As seen in FIG. 2, the battery diode BD01 is connected to first coil L1 of a transformer and fifth capacitor C5. A variety of different inseparable assemblies can be formed as integrated circuits or chips soldered onto a circuit board. The first capacitor C1 is connected to thirteenth inseparable assembly U7C. The fifth capacitor C5 is connected to second resistor R02. The sixth capacitor C6 is connected to first diode D1. The seventh capacitor C7 is connected to second ground capacitor CY2. The eighth capacitor C8 is connected to third diode D3. The twelfth capacitor C12 is connected to twelfth resistor R12. The thirteenth capacitor C13 is connected to twentieth resistor R20 and twelfth resistor R12. The sixteenth capacitor C16 is connected to twenty-second resistor R22 and third inseparable assembly U2B. The seventeenth capacitor C17 is connected to eleventh diode D11. The eighteenth capacitor C18 is connected to ninety-first resistor R91. The nineteenth capacitor C19 is connected to forty-fifth resistor R45. The twentieth capacitor C20 is connected to fourth resistor R4. The twenty-first capacitor C21 is connected to thirty-fourth resistor R34. The twenty-second capacitor C22 is connected a battery voltage. The twenty-sixth capacitor C26 is connected to thirty-eighth resistor R38. The twenty-eighth capacitor C28 is connected to forty-seventh resistor R47 and R49 forty-ninth resistor R49. The twenty-ninth capacitor C29 is connected to fifty-second resistor R52. The eighty-fourth capacitor C84 is connected to seventh diode D7. The eighty-fifth capacitor C85 is connected to eighty-eight resistor R88. The capacitor for transformer CX1 is connected to variable resistor RV1. The first ground capacitor CY1 is connected to EARTH earth. The second ground capacitor CY2 is connected to tenth inseparable assembly U6B. The first diode D1 is connected to supplemental tenth resistor R10A. The second diode D2 is connected to thirty-fourth resistor R34. The third diode D3 is connected to eighth capacitor C8. The fourth diode D4 is connected to The contact bus K10. The fifth diode D5 is connected to battery voltage. The sixth diode D6 is connected to seventeenth resistor R17. The seventh diode D7 is connected to eighty-fourth capacitor C84. The eighth diode D8 is connected to fifteenth resistor R15. The ninth diode D9 is connected to fortieth resistor R40. The tenth diode D10 is connected to battery voltage. The eleventh diode D11 is connected to second inseparable assembly U2A. The EARTH earth is connected to first ground capacitor CY1. The FUSE fuse is connected to variable resistor RV1. The variable resistor can be connected to a knob to allow control of the variable resistor. A variety of knobs can be provided for controlling operation of the high bay battery backup module 20, such as by controlling the dimming level of the lamp for example.

The contact bus K10 can allow construction in multiple parts such as on multiple circuit boards connected together at a bus. The contact bus K10 pin one is connected to third resistor R3, thirty-eighth resistor R38 and twenty-sixth capacitor C26. The contact bus K10 pin two is connected to second transistor Q2 and fourth transistor Q4. The contact bus K10 pin three is connected to twenty-sixth resistor R26 and third transistor Q3. The contact bus K10 pin four is connected to twenty-ninth capacitor C29, fifty-second resistor R52, twenty-fifth resistor R25, forty-ninth resistor R49, forty-seventh resistor R47 and twenty-eighth capacitor C28. The contact bus K10 pin five is connected to sixteenth capacitor C16, twenty-second resistor R22 and third inseparable assembly U2B.

The first coil L1 of a transformer is connected to battery diode BD01. The third connector P3 is connected to ninth connector P9 and first schottky diode Z4. The fourth connector P4 is connected to eleventh connector P11. The fifth connector P5 is connected to second relay Relay2. The eighth connector P8 is connected to first schottky diode Z4. The ninth connector P9 is connected to third connector P3 and second electrolytic capacitor CC2. The tenth connector P10 is connected to eighteenth resistor R18 , nineteenth resistor R19 and first switch S1 The eleventh connector P11 is connected to variable resistor RV1 and capacitor for transformer CX1. The twelfth connector P12 is connected to FUSE fuse, resistor RV1 and capacitor for transformer CX1. The first transistor Q1 is connected to second diode D2, thirty-fourth resistor R34, twenty-first capacitor C21 and battery voltage. The second transistor Q2 is connected to fourth transistor Q4. The third transistor Q3 is connected to twenty-sixth resistor R26. The fourth transistor Q4 is connected to second transistor Q2. The fifth transistor Q5 is connected to thirty-seventh resistor R37. The sixth transistor Q6 is connected to forty-first resistor R41. The second relay Relay2 is connected to capacitor for transformer CX1.

First resistor R01 is connected to supplemental tenth resistor R10A, first diode D1 and sixth capacitor C6. The second resistor R02 is connected to tenth inseparable assembly U6B. The third resistor R3 is connected to twentieth capacitor C20, thirty-eighth resistor R38 and fourth resistor R4.The fourth resistor R4 is connected to fifteenth resistor R15 and second transformer T2B. The second charging resistor R8C is connected to twelfth capacitor C12. The tenth resistor R10 is connected to supplemental tenth resistor R10A. The supplemental tenth resistor R10A is connected to first diode D1 and sixth capacitor C6. The twelfth resistor R12 is connected to twelfth capacitor C12. The primary thirteenth resistor R13 is connected to twenty-first resistor R21 and seventeenth capacitor C17. The secondary thirteenth resistor R13D is connected to forty-first resistor R41, thirty-third resistor R33, quaternary thirteenth resistor R13H, tertiary thirteenth resistor R13E, forty-fifth resistor R45 and forty-sixth resistor R46. The tertiary thirteenth resistor R13E is connected to forty-first resistor R41, thirty-third resistor R33, quaternary thirteenth resistor R13H, forty-fifth resistor R45 and forty-sixth resistor R46. The quaternary thirteenth resistor R13H is connected to secondary thirteenth resistor R13D, forty-first resistor R41, thirty-third resistor R33,tertiary thirteenth resistor R13E, forty-fifth resistor R45 and forty-sixth resistor R46. The fifteenth resistor R15 is connected to fourth resistor R4, second transformer T2B, twenty-sixth capacitor C26 and thirty-eighth resistor R38. The sixteenth resistor R16 is connected to thirty-fifth resistor R35, third electrolytic capacitor CC3 and eighth capacitor C8. The seventeenth resistor R17 is connected to seventh diode D7, sixth diode D6 . The eighteenth resistor R18 is connected to nineteenth resistor R19, primary thirteenth resistor R13, twenty-first resistor R21, second inseparable assembly U2A, seventeenth capacitor C17 nineteenth resistor and tenth plug 10. The R19 is connected to eighteenth resistor R18 , primary thirteenth resistor R13, twenty-first resistor R21, second inseparable assembly U2A, seventeenth capacitor C17 and tenth plug 10. The twentieth resistor R20 is connected to thirteenth capacitor C13. The twenty-first resistor R21 is connected to R19 is connected to eighteenth resistor R18 , primary thirteenth resistor R13, second inseparable assembly U2A, seventeenth capacitor C17 and tenth plug 10. The twenty-second resistor R22 is connected to third inseparable assembly U2B, sixteenth capacitor C16 and contact bus K10 pin five. The twenty-fourth resistor R24 is connected to second transistor Q2 and fourth transistor Q4. The twenty-fifth resistor R25 is connected to fifty-second resistor R52, forty-seventh resistor R47, forty-ninth resistor R49, twenty-eighth capacitor C28, twenty-ninth capacitor C29 and contact bus K10 pin four. The twenty-sixth resistor R26 is connected to third transistor Q3 and contact bus K10 pin three. The twenty-seventh resistor R27 is connected to second transistor Q2 and fourth transistor Q4. The thirty-second resistor R32 is connected to nineteenth capacitor C19 fiftieth resistor R50 and fifty-first resistor R51 . The thirty-third resistor R33 is connected to secondary thirteenth resistor R13D is connected to forty-first resistor R41,tertiary thirteenth resistor R13E, forty-fifth resistor R45 and forty-sixth resistor R46. The thirty-fourth resistor R34 is connected to twenty-first capacitor C21. first transformer T2A. The thirty-fifth resistor R35 is connected to sixteenth resistor R16, third electrolytic capacitor CC3 and eighth capacitor C8. The thirty-seventh resistor R37 is connected to sixth transistor Q6.The thirty-eighth resistor R38 is connected to twenty-sixth capacitor C26, third resistor R3 and twentieth capacitor C20. The thirty-ninth resistor R39 is connected to fortieth resistor R40 and ninth diode D9. The fortieth resistor R40 is connected to thirty-ninth resistor R39 and ninth diode D9. The forty-first resistor R41 is connected to thirty-third resistor R33, quaternary thirteenth resistor R13H, tertiary thirteenth resistor R13E, forty-fifth resistor R45 and forty-sixth resistor R46. The forty-fifth resistor R45 is connected to thirty-third resistor R33, quaternary thirteenth resistor R13H, tertiary thirteenth resistor R13E and forty-sixth resistor R46. The forty-sixth resistor R46 is connected to thirty-third resistor R33, quaternary thirteenth resistor R13H, tertiary thirteenth resistor R13E and nineteenth capacitor C19. The forty-seventh resistor R47 is connected to forty-ninth resistor R49 and twenty-eighth capacitor C28. The forty-eighth resistor R48 is connected to nineteenth capacitor C19 and twenty-eighth capacitor C28. The forty-ninth resistor R49 is connected to twenty-fifth resistor R25 and twenty-eighth capacitor C28. The fiftieth resistor R50 is connected to fifty-first resistor R51 and first amplifier Z5A. The fifty-first resistor R51 is connected to fiftieth resistor R50 and first amplifier Z5A. The fifty-second resistor R52 is connected to twenty-ninth capacitor C29 and twenty-fifth resistor R25. The eighty-first resistor R81 is connected to eighty-second resistor R82 and ninetieth resistor R90. The eighty-second resistor R82 is connected to ninetieth resistor R90. The eighty-seven resistor R87 is connected to eighty-fourth capacitor C84 and eleventh inseparable assembly U7A. The eighty-eight resistor R88 is connected to eighty-fifth capacitor C85 and twelfth inseparable assembly U7B. The eighty-ninth resistor R89 is connected to ninetieth resistor R90 and twelfth inseparable assembly U7B. The ninetieth resistor R90 is connected to eighty-ninth resistor R89 and eighty-first resistor R81. The ninety-first resistor R91 is connected to ground diode Z1 and twelfth inseparable assembly U7B. The variable resistor RV1 is connected to eleventh connector P11 and twelfth connector P12. The first switch Si is connected to capacitor for transformer CX1 and battery diode BD01. The first transformer T2A is connected to fortieth resistor R40 and thirty-fourth resistor R34. The second transformer T2B is connected to eighth diode D8 and fifteenth resistor R15. The first inseparable assembly U1 is connected to second resistor R02 and seventh capacitor C7. The second inseparable assembly U2A is connected to twenty-first resistor R21 and seventeenth capacitor C17. The third inseparable assembly U2B is connected to twenty-second resistor R22 and sixteenth capacitor C16. The ninth inseparable assembly U6A is connected to seventeenth resistor R17. The tenth inseparable assembly U6B is connected to second ground capacitor CY2. The eleventh inseparable assembly U7A is connected to eighty-fourth capacitor C84. The twelfth inseparable assembly U7B is connected to eighty-fifth capacitor C85. The thirteenth inseparable assembly U7C is connected to first capacitor C1. The ground diode Z1 is connected to ninety-first resistor R91, first capacitor C1. The first schottky diode Z4 is connected to third connector P3 and eighth connector P8. The first amplifier Z5A is connected to fifty-second resistor R52 and fiftieth resistor R50.

As seen in FIG. 3, the second capacitor C2 is connected to fourteenth resistor R14 and twenty-eight resistor R28. The third capacitor C3 is connected to eighth resistor R8 and eightieth resistor R80. The fourth capacitor C4 is connected to battery voltage and seventh inseparable assembly U4C. The ninth capacitor C9 is connected to first resistor R1 and thirtieth resistor R30. The tenth capacitor C10 is connected to second schottky diode Z3.The eleventh capacitor C11 is connected to one hundred first resistor R101 and fourth inseparable assembly U3. The fourteenth capacitor C14 is connected to ninth resistor R9 and eleventh resistor R11. The fifteenth capacitor C15 is connected to eleventh resistor R11 and fifth inseparable assembly U4A. The twenty-third capacitor C23 is connected to thirty-first resistor R31. The twenty-fourth capacitor C24 is connected to eighth inseparable assembly U5 and thirty-sixth resistor R36. The twenty-fifth capacitor C25 is connected to seventeenth inseparable assembly U9C. The twenty-seventh capacitor C27 is connected to forty-second resistor R42 and forty-third resistor R43.The thirtieth capacitor C30 is connected to second amplifier Z5B. The thirty-first capacitor C31 is connected to twenty-third resistor R23. The sixty-first capacitor C61 is connected to battery voltage and sixty-second resistor R62. The one hundred second capacitor C102 is connected to one hundred third capacitor C103. The one hundred third capacitor C103 is connected to one hundred second capacitor C102. The positive diode D+ is connected to eighth resistor R8 and third capacitor C3. The twelfth diode D12 is connected to battery voltage. The contact bus K10 pin one is connected to first resistor R1. The contact bus K10 pin two is connected to pin five of fourteenth inseparable assembly U8. The contact bus K10 pin three is connected to pin six of fourteenth inseparable assembly U8. The contact bus K10 pin four is connected to pin six three fourteenth inseparable assembly U8. The contact bus K10 pin five is connected to pin eight of fourteenth inseparable assembly U8. The third coil L3 is connected to first connector P1, second connector P2, sixth connector P6 and seventh connector P7. The first connector P1 is connected to third coil L3. The second connector P2 is connected to third coil L3. The sixth connector P6 is connected to third coil L3. The seventh connector P7 is connected to third coil L3. The thirteenth connector P13 is connected to third capacitor C3 and eightieth resistor R80. The seventh transistor Q7 is connected to twelfth diode D12. The first resistor R1 is connected to K10 pin one. The fifth resistor R5 is connected to sixth resistor R6. The sixth resistor R6 is connected to fifth resistor R5.The seventh resistor R7 is connected to pin nine of fourteenth inseparable assembly U8.The eighth resistor R8 is connected to positive diode D+ and third capacitor C3. The first charging resistor R8A is connected to sixty-second resistor R62 and sixty-first capacitor C61.The third charging resistor R8CC is connected to pin ten of fourteenth inseparable assembly U8. The ninth resistor R9 is connected to pin seven of fourteenth inseparable assembly U8. The eleventh resistor R11 is connected to fourteenth capacitor C14 and fifteenth capacitor C15.The fourteenth resistor R14 is connected to second capacitor C2. The twenty-third resistor R23 is connected to thirty-first capacitor C31. The twenty-eight resistor R28 is connected to fifteenth inseparable assembly U9A. The twenty-nine resistor R29 is connected to fifteenth inseparable assembly U9A. The thirtieth resistor R30 is connected to twenty-third capacitor C23. The thirty-first resistor R31 is connected to sixteenth inseparable assembly U9B. The thirty-sixth resistor R36 is connected to eighth inseparable assembly U5. The forty-second resistor R42 is connected to twenty-seventh capacitor C27. The forty-third resistor R43 is connected to twenty-seventh capacitor C27. The forty-fourth resistor R44 is connected to forty-third resistor R43. The sixty-first resistor R61 is connected to sixty-first capacitor C61. The sixty-second resistor R62 is connected to sixty-first capacitor C61. The fourth charging resistor R80 is connected to third charging resistor R8CC. thirteenth connector P13 and third capacitor C3. The one hundred first resistor R101 is connected to eleventh capacitor C11.The fourth inseparable assembly U3 is connected to one hundred first resistor R101 and eleventh capacitor C11. The fifth inseparable assembly U4A is connected to sixth inseparable assembly U4B. The sixth inseparable assembly U4B is connected to fifth inseparable assembly U4A.

The seventh inseparable assembly U4C is connected to fourth capacitor C4. The eighth inseparable assembly U5 is connected to twenty-fourth capacitor C24.The fourteenth inseparable assembly U8 is connected to twenty-third resistor R23, thirty-first capacitor C31, twenty-nine resistor R29, K10 pin four, K10 pin two, K10 pin three, ninth resistor R9, fourteenth capacitor C14, eleventh resistor R11, fifteenth capacitor C15 , fifth inseparable assembly U4A, forty-fourth resistor R44, forty-third resistor R43, forty-second resistor R42, twenty-seventh capacitor C27, first charging resistor R8A, sixty-second resistor R62, sixty-first capacitor C61, sixty-first resistor R61, twenty-third capacitor C23, thirtieth resistor R30 , third charging resistor R8CC, eightieth resistor R80, third capacitor C3, thirteenth connector P13, eighth resistor R8, positive diode D+, seventh resistor R7, seventh transistor Q7 and twelfth diode D12. The fifteenth inseparable assembly U9A is connected to twenty-nine resistor R29. The sixteenth inseparable assembly U9B is connected to thirty-first resistor R31. The seventeenth inseparable assembly U9C is connected to twenty-fifth capacitor C25. The second schottky diode Z3 is connected to tenth capacitor C10. The second amplifier Z5B is connected to thirtieth capacitor C30.

The fourteenth inseparable assembly U8 is preferably a processor providing controls for the dimming circuit. The processor controls battery charging through the battery charging circuit, provides dimming control through the dimming circuit, and controls power supply to the lamp.

During normal operation, the processor provides continual power to the lamp while slowly charging the battery. When power is interrupted, the processor is configured to dim the lamp and change to battery power.

1. A battery backup module comprising:
a. a housing including a heatsink having vertically oriented heat dissipation fins extending horizontally from the heatsink, wherein the heatsink further includes vertically oriented heat dissipation grooves;
b. a battery housed within the housing and thermally connected to the heatsink;
c. a circuit, wherein the circuit includes a processor, wherein the circuit is configured to govern battery charging, battery usage, and wherein the processor is configured to handle dimming control, wherein the circuit includes a battery charging circuit, a power supply circuit and a dimming circuit;
d. a module power line in connected to the circuit, supplying electricity to the circuit; and a module power line out configured to connect to a lamp power line of a lamp.

2. The battery backup module of claim 1, wherein the processor is configured for simultaneously control of battery charging through the battery charging circuit, dimming control through the dimming circuit, and power supply control to the lamp through a power supply circuit.

3. The battery backup module of claim 1, wherein the processor is configured to provide continual power to the lamp while slowly charging the battery during normal operation mode, but when power is interrupted to dim the lamp and change to battery power in an emergency mode.

4. The battery backup module of claim 1, further including a variable resistor for providing a preset dimming level input to the processor.
